(19) United States
(12) Patent Application Publication
(10) Pub. No.: US 2005/0125235 A1
(43) Pub. Date: Jun. 9, 2005

(54) Method and apparatus for using earcons in mobile communication devices

(75) Inventors: Thomas Lazay, Boston, MA (US); Jordan Cohen, Gloucester, MA (US); Tracy Mather Zlatkova, Boston, MA (US); William Barton, Harvard, MA (US)

Correspondence Address: WILMER CUTLER PICKERING HALE AND DORR LLP, 60 STATE STREET, BOSTON, MA, 02109, US

(73) Assignee: Voice Signal Technologies, Inc., Woburn, MA (US)

(21) Appl. No.: 10/932,341

(22) Filed: Sep. 1, 2004

Related U.S. Application Data
(60) Provisional application No. 60/501,971, filed on Sep. 11, 2003.

(51) Int. Cl. G10L 21/00

(52) U.S. Cl. 704/275

(57) ABSTRACT

The apparatus and methods for using earcons as user prompts in mobile communication devices described herein are directed to implementing a mode of communication in these communication devices having speech recognition capabilities wherein spoken prompts are disabled and replaced with short identifiable sound prompts such as the earcons. In general, according to one aspect of the invention, a method for operating a communication device that includes speech recognition capabilities, comprises implementing on the device a user interface that employs a plurality of different user prompts, wherein each user prompt is for soliciting a corresponding spoken input from the user or informing the user about an action or state of the device; implementing on the device a plurality of different earcons, each earcon being mapped to a corresponding different one of the plurality of user prompts; and when any selected one of said plurality of user prompts is issued by the user interface on the device, generating the earcon that is mapped to the selected user prompt. Each prompt of the plurality of user prompts has a corresponding language representation and wherein generating the earcon for the selected user prompts includes generating the corresponding language representation through the user interface.

### CROSS-REFERENCE TO RELATED APPLICATIONS

This application claims the benefit of U.S. Provisional Patent Application Ser. No. 60/501,971 filed Sep. 11, 2003, the entire contents of which is incorporated herein by reference.

### TECHNICAL FIELD

This invention relates to operating wireless communication devices using a user interface having earcons as user prompts.

### BACKGROUND

Mobile voice communication devices such as cellular telephones (cell phones) have primarily functioned to transmit and receive voice communication signals. But as the technology has advanced in recent years, additional functions have also become available on cellular phones. Examples of this added functionality include, but are not limited to, an onboard telephone directory, voice recognition capabilities, voice-activation features, games and notebook functions. Not only are these capabilities being added to cellular phones but voice communication capabilities are being added to computing platforms such as the PDA (personal digital assistant); thus blurring the distinction between cellular phones and other handheld computing devices.

One example of a modern mobile communication and computing device is the T-Mobile pocket PC Phone Edition, which includes a cellular telephone integrated with a handheld computing device running the Microsoft Windows CE operating system. The pocket PC includes an Intel Corporation StrongArm processor running at 206 MHz, has 32 MB of RAM (memory), desktop computer interface and a color display. The pocket PC is a mobile platform meant to provide the functions of a cellular telephone and a PDA in a single unit.

The cellular phones commonly employ multimedia interfaces. For example, a user can interface with cell phones visually by receiving information on a display, audibly by listening to prompts, verbally by speaking into the interface, and also by touching the keys on a keypad. The prompts facilitate the interaction between a user and the device. They tell the user what the application is expecting, what the application has heard (or seen or felt), or it contains information about the expectations of the application with respect to the actions of the user.

For instance, in the VST (Voice Signal Technologies, Inc.) digit dialing application (A-500), the application displays “number please” on the screen, and simultaneously says “please say the number [beep]” through the earpiece of the handset. These are both cues to the user that he or she should speak a telephone number, and the [beep] is an audible cue that indicates that the handset is ready to listen for the number.

A problem with this arrangement is that it takes time to listen to “please say the number”. One standard way to handle this situation is to have barge-in, where the process is simultaneously speaking and listening. Upon hearing the talker begin to talk, the process output is terminated, and it is assumed that the talker is talking as if he had heard the entire prompt. The practiced user of these processes can then proceed through an interaction in a much smaller time, as he does not have to listen to most of the prompting material. This state-of-the-art solution has two difficulties:
a. The device must be capable of simultaneous speaking and listening, and
b. The barge-in is sensitive to background noise and other acoustic interference.

### SUMMARY OF THE INVENTION

The apparatus and methods for using audible, non-verbal cues (earcons) as user prompts in mobile communication devices described herein are directed to implementing a mode of communication in these communication devices having speech recognition capabilities wherein spoken prompts are disabled and replaced with the short identifiable sound prompts (earcons).

The substitution of earcons for prompting phrases in an application such as digit dialing can reduce the time to accomplish different functions, for example, as dial a phone number by half of the time or less, depending on the speaking rate and success of the user of the phone number. Using the earcons rather than full prompts thus makes transactions much faster.

In general, according to one aspect of the invention, a method for operating a communication device that includes speech recognition capabilities, comprises implementing on the device a user interface that employs a plurality of different user prompts, wherein each user prompt is for either soliciting a corresponding spoken input from the user or informing the user about an action or state of the device; implementing on the device a plurality of different earcons, each earcon being mapped to a corresponding different one of the plurality of user prompts; and when any selected one of said plurality of user prompts is issued by the user interface on the device, generating the earcon that is mapped to the selected user prompt. Each prompt of the plurality of user prompts has a corresponding language representation and wherein generating the earcon for the selected user prompts includes generating the corresponding language representation through the user interface. The generation of the corresponding language representation through the user interface includes visually displaying the language representation to the user, or audibly presenting said language representation to the user. Each of the plurality of different earcons comprise a distinctive sound and can include at least one of compressed speech, a plurality of abstract sounds, and a plurality of sounds having different attributes such as varying pitch, tone and frequency.

The method further includes implementing a plurality of user selectable modes having different user prompts including a first mode in which whenever any of the plurality of different earcons is generated the corresponding language representation is also presented to the user, and a second mode in which the plurality of different earcons are generated without presenting the corresponding language representation. The second mode may be selected by the user after operating the device in the first mode wherein the presentation of language representation is then disabled.

In general, according to another aspect of the invention, a mobile voice communication device includes a wireless transceiver circuit for transmitting and receiving auditory information and for receiving data; a processor; and a memory storing executable instructions which when executed on the processor causes the mobile voice communication device to provide functionality to a user of the mobile voice communication device. The executable instructions include implementing on the device a user interface that employs a plurality of different user prompts, wherein each user prompt of said plurality of different user prompts is for either soliciting a corresponding spoken input from the user or informing the user about an action or state of the device; implementing on the device a plurality of different earcons, each earcon of said plurality of different earcons being mapped to a corresponding different one of said plurality of user prompts; and when any selected one of said plurality of user prompts is issued by the user interface on the device, generating the earcon that is mapped to the selected user prompt. The mobile communication device is a mobile telephone having speech recognition capabilities.

According to another aspect of the invention, a computer readable medium having stored instructions adapted for execution on a process, includes instructions for implementing on the device a user interface that employs a plurality of different user prompts, wherein each user prompt of said plurality of different user prompts is either for soliciting a corresponding spoken input from the user or informing the user about an action or state of the device; instructions for implementing on the device a plurality of different earcons, each earcon of said plurality of different earcons being mapped to a corresponding different one of said plurality of user prompts; and instructions for when any selected one of said plurality of user prompts is issued by the user interface on the device, generating the earcon that is mapped to the selected user prompt. The medium is disposed within a mobile telephone apparatus and operates in conjunction with a user interface.

According to still another aspect of the invention, a mobile voice communication device, includes a first communication mode selectable by a user, wherein the user interface of the device generates at least two different types of user prompts for soliciting a corresponding spoken input from the user or informing the user about an action or state of the device, wherein one of the at least two prompts is a plurality of language prompts and one is a plurality of earcon prompts; and a second communication mode selectable by the user, wherein the user interface of the device generates only a plurality of earcon prompts. Once the user has learned the association between each of the plurality of language prompts and each of the plurality of earcon prompts, the user selects the second mode by disabling the plurality of language prompts. Each of the plurality of earcon prompts is a distinctive sound. These earcon prompts include at least one of compressed speech, a plurality of abstract sounds, and a plurality of sounds having varying pitch, tone and frequency attributes.

The foregoing and other features and advantages of the invention will be apparent from the following description of embodiments of the invention, as illustrated in the accompanying drawings.

### BRIEF DESCRIPTION OF THE DRAWINGS

FIGS. 1A-1H illustrate different views of a display screen of a user interface on the mobile telephone device using different user prompts.

FIG. 2 is a flow diagram of a process for providing an operation mode using earcon prompts.

FIG. 3 is a block diagram of a cellular phone (Smartphone) on which the functionality described herein can be implemented.

### DETAILED DESCRIPTION

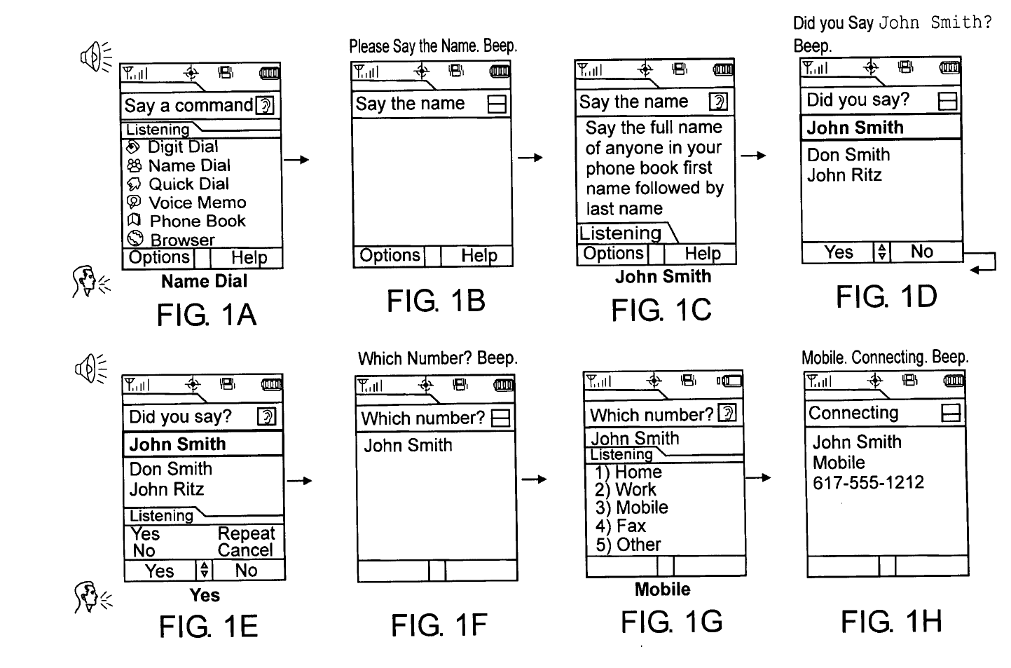

FIGS. 1A-1H illustrate an example of the operation of a user interface when earcons are used to communicate prompts to the user. This approach can be used on any interface or any flow in which user prompts are generated to solicit user input. The different views illustrate display screens of a user interface of a mobile communication device such as a cellular phone. When a user first launches an application by pressing a launch key such as “Record” or “Talk” on the communication device, the device provides a menu screen and prompts the user to “say a command” by providing the language representation of the prompt visually or audibly as illustrated in FIG. 1A.

In a first mode, the device communicates with the user by providing visual, speech and earcon prompts. The earcon prompts are audible, non-verbal cues, each having its own distinctive sound which the user learns to associate with a corresponding verbal command or instruction. An earcon is an auditory icon that is used to audibly represent a user prompt. The earcons are mapped to corresponding language representation in the application program. When a device obtains a user input in response to an earcon, a function assigned or correlated to the prompt is executed in the application. Earcons include, but are not limited to, natural sounds, abstract sounds, compressed speech, and sounds having different tone, frequency or pitch attributes.

In a second operational mode for the more experienced users who has learned the association between the different earcons and their corresponding commands or instructions the device uses only earcons as prompts to communicate with the user. For example, the device provides a distinctive sound prompt associated with a speech prompt “say a command.” The user then responds to the earcon prompt by saying a command such as, for example, “name dial.” The selected name dial functionality in the device lets users dial any number in their phonebook by saying the name of the entry and for entries with more than one number, specifying a location. The device prompts the user to say the name of the entry by providing a second prompt as illustrated in FIGS. 1B and 1C. Depending upon the mode selected by the user, the user interface provides the user with different prompts which are either visual or audible. In the first mode, the prompt is a speech prompt, for example, “please say a name.” In the second mode, the prompt is an earcon such as a distinctive “beep.” The application maps a speech prompt “please say a name” to the corresponding earcon prompt and a user response to either of the two prompts results in the same action provided by the device.

The exemplary name dial application in the device then provides a third prompt to the user to confirm the name articulated as shown in FIG. 1D and FIG. 1E. Upon receiving a confirmation, the device then provides a prompt which is associated with the next query “which number?” for name entries with more than one number specifying a particular location, for example, home or work as shown in FIGS. 1F and 1G. The device then presents the user with a prompt indicating that the user is being connected to the requested number as shown in FIG. 1H.

The exemplary prompts as described with respect to FIGS. 1A-1H, for a particular feature (name dial) are all manifested as earcon prompts in the communication mode selected by the experienced user who has associated each earcon with the corresponding language representation. Each of the earcon prompts are mapped to the particular language prompts which are provided either audibly by the user interface as speech prompts or visually as text prompts. The mapping is provided in the application code or executable instructions and stored in memory. The user navigates the different menus and accesses the enhanced features offered by the application at a faster rate once they have identified each earcon presented by the device with the associated speech prompt such as “please say name”, “did you say ‘X’”, “which number?”.

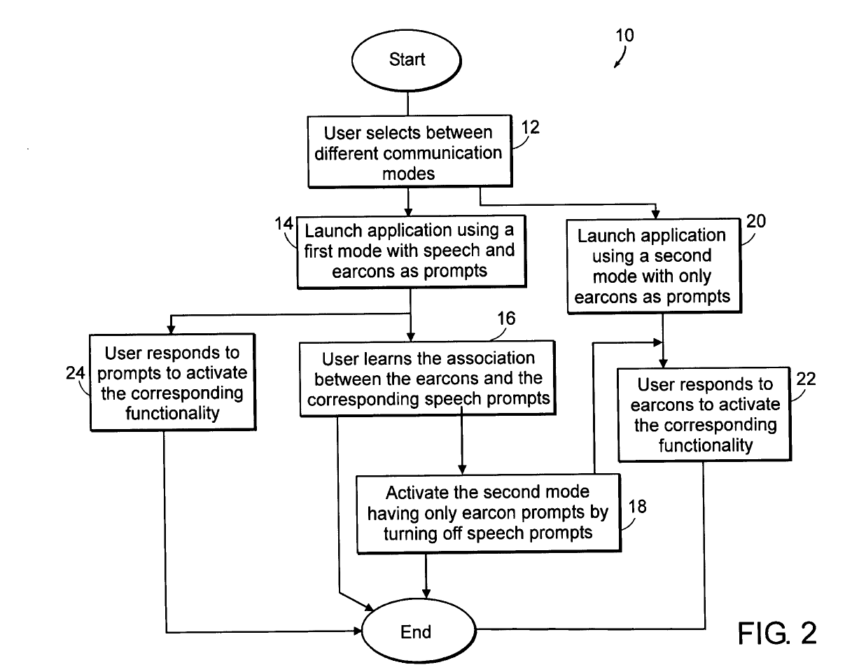

FIG. 2 illustrates a flow diagram of a process 10 for providing different selectable communication modes in a wireless communication device such as a cell phone. A user purchases the cell phone including embedded software with the enhanced functionality of providing different communication modes including different options for user prompts provided by the user interface of the device. The user selects the communication mode most convenient for their use per step 12. In one mode, the user interface of the device provides user prompts that are audible speech prompts associated with a language representation as well as earcon prompts. In this mode, the device may additionally present the user with visual text prompts associated with the same language representation. This first mode is used by a user not familiar with earcon prompts alone. In a second mode, the user interface provides earcon prompts for interfacing with the voice-recognition applications. Speech prompts are disabled or turned off in this second or “expert” mode, thus, providing faster interaction times between the user and the cell phone.

If the user selects the first (beginner) mode, he or she launches the application wherein the user interface provides both speech prompts and earcon prompts per step 14. Over time, the user learns the association between the prompts presented as earcons with the speech or text prompts. The user may also learn the association between the earcon prompts and the speech prompts by using an instruction manual that may be provided electronically.

The user selects the second mode of communication with the device at anytime once they have associated the prompts provided as earcons with the corresponding language representation. Once the user has learned the relationship between the earcon prompts (beeps) and their respective phrases, the spoken prompts are not needed and the user can then select the second (expert) mode directly upon turning on the phone per step 20. The user can also switch to the expert (second) mode from the first mode per step 18 by turning off or disabling the speech prompts.

The earcons used in the methods described herein include any identifiable sound that is preferably short and simple to produce. The earcons can include, for example, but are not limited to: (1) morse code or some similar code to play a letter or two of the prompt (a series of long and short tones); (2) mimicing the pitch of the carrier phrase, although in a shorter time scale (for example, higher pitch at the end for a question, and dropping at the end for a statement); (3) play portions of the vowels which occur in the carrier phrase (“please say the number” could then be played as “EE AY UH UH ER”, which are shorter than the full phrase); (4) the energy of the [beep] can mimic the energy of the carrier phrase, but at a shorter time scale; (5) a number of beeps, from 1 to n, could represent the carrier phrases; (6) each beep can be a different frequency, but they would be different enough to be discriminated auditorily; (7) the earcon can be an aggressively compressed version of the prompts, (the compression can be modulated by the user and thus be controllable by the user); (8) the earcons can vary by tambre (the difference between a violin, a piano, and a flute all playing the same note); (9) the earcons can vary by any other distinguishable characteristic; and (10) earcons that can be designed using any combination of the above.

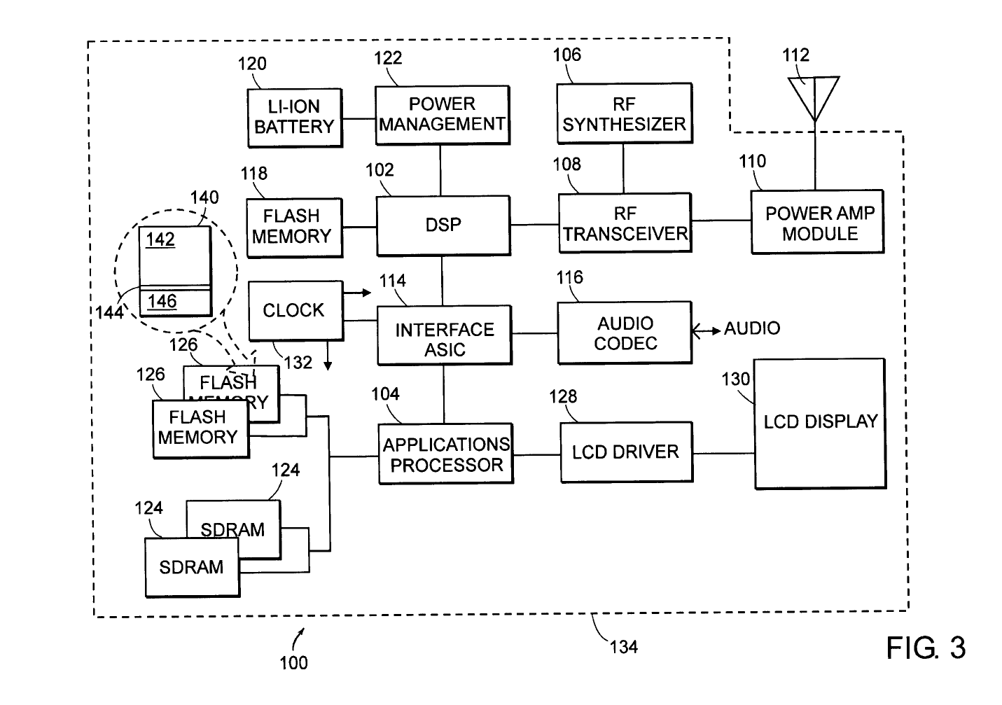

FIG. 3 illustrates a typical platform on which the functionality of a communication mode having earcons as prompts is provided. The platform is a cellular phone in which there is embedded application software that includes the relevant functionality. In this instance, the application software includes, among other programs, voice recognition software that enables the user to access information on the phone (e.g. telephone numbers of identified persons) and to control the cell phone through verbal commands. The verbal commands in an expert mode are provided in response to earcon prompts. The voice recognition software may also include enhanced functionality in the form of a speech-to-text function that enables the user to enter text into an email (electronic mail) message through spoken words.

The smartphone 100 is a Microsoft PocketPC-powered phone which includes at its core a baseband DSP 102 (digital signal processor) for handling the cellular communication functions including, for example, voiceband and channel coding functions and an applications processor 104 (for example, Intel StrongArm SA-1110) on which the PocketPC operating system runs. The phone supports GSM (global system for mobile communications) voice calls, SMS (Short Messaging Service) text messaging, wireless email (electronic mail), and desktop-like web browsing along with more traditional PDA (personal digital assistant) features.

The transmit and receive functions are implemented by a RF (radio frequency) synthesizer 106 and an RF radio transceiver 108 followed by a power amplifier module 110 that handles the final-stage RF transmit duties through an antenna 112. An interface ASIC (application specific integrated circuit) 114 and an audio CODEC (compression/decompression) 116 provide interfaces to a speaker, a microphone, and other input/output devices provided in the phone such as a numeric or alphanumeric keypad (not shown) for entering commands and information.

The DSP 102 uses a flash memory 118 for code store. A Li-Ion (lithium-ion) battery 120 powers the phone and a power management module 122 coupled to DSP 102 manages power consumption within the phone. Volatile and non-volatile memory for applications processor 114 is provided in the form of SDRAM (synchronized dynamic random access memory) 124 and flash memory 126, respectively. This arrangement of memory is used to store the code for the operating system, the code for customizable features such as the phone directory, and the code for any applications software that might be included in the smartphone, including the voice recognition software mentioned herein before. The visual display device for the smartphone includes an LCD (liquid crystal display) driver chip 128 that drives an LCD display 130. There is also a clock module 132 that provides the clock signals for the other devices within the phone and provides an indicator of real time.

All of the above-described components are packaged within an appropriately designed housing 134.

Since the smartphone described herein before is representative of the general internal structure of a number of different commercially available smartphones and since the internal circuit design of those phones is generally known to persons of ordinary skill in this art, further details about the components shown in FIG. 3 and their operation are not being provided and are not necessary to understanding the invention.

The internal memory of the phone includes all relevant code for operating the phone and for supporting its various functionality, including code 140 for the voice recognition application software, which is represented in block form in FIG. 3. The voice recognition application includes code 142 for its basic functionality as well as code 144 for enhanced functionality, which in this case is speech-to-text functionality 144. The code or sequence of executable instructions for the selectable communication modes using for one, earcon prompts as described herein is stored in the internal memory of a phone and as such can be implemented on any phone or communication device having an application processor.

It will be apparent to those of ordinary skill in the art that methods involved in the communication mode using earcons may be embodied in a computer program product that includes a computer usable medium. For example, such a computer usable medium can include a readable memory device, such as, a hard drive device, a CD-ROM, a DVD-ROM, or a computer diskette, having computer readable program code segments stored thereon. The computer readable medium can also include a communications or transmission medium, such as, a bus or a communications link, either optical, wired, or wireless having program code segments carried thereon as digital or analog data signals. This embodiment can be used in mobile communication devices having different computing platforms.

Other aspects, modifications, and embodiments are within the scope of the following claims.

1. A method for operating a communication device that includes speech recognition capabilities, the method comprising:
implementing on the device a user interface that employs a plurality of different user prompts, wherein each user prompt of said plurality of different user prompts is for either soliciting a corresponding spoken input from the user or informing the user about an action or state of the device;
implementing on the device a plurality of different earcons, each earcon of said plurality of different earcons being mapped to a corresponding different one of said plurality of user prompts; and
when any selected one of said plurality of user prompts is issued by the user interface on the device, generating the earcon that is mapped to the selected user prompt.

2. The method of claim 1, wherein each prompt of the plurality of user prompts has a corresponding language representation and wherein generating the earcon for the selected user prompts comprises generating the corresponding language representation through the user interface.

3. The method of claim 2, wherein generating the corresponding language representation through the user interface further comprises visually displaying said language representation to the user.

4. The method of claim 2, wherein generating the corresponding language representation through the user interface further comprises audibly presenting said language representation to the user.

5. The method of claim 1, wherein each of the plurality of different earcons comprise a distinctive sound.

6. The method of claim 1, wherein the plurality of different earcons include at least one of compressed speech, a plurality of abstract sounds, and a plurality of sounds having different attributes such as varying pitch, tone and frequency.

7. The method of claim 2, further comprising:
implementing a plurality of user selectable modes having different user prompts.

8. The method of claim 7, further comprising a first mode in which whenever any of the plurality of different earcons is generated the corresponding language representation is also presented to the user.

9. The method of claim 8, further comprising a second mode in which the plurality of different earcons are generated without presenting the corresponding language representation.

10. The method of claim 9, further comprising selecting the second mode after operating the device in the first mode wherein the presentation of language representation is disabled.

11. The method of claim 1, wherein the device includes speech recognition capabilities to process an input from the user in response to the plurality of different earcons.

12. A mobile voice communication device comprising:
a wireless transceiver circuit for transmitting and receiving auditory information and for receiving data;
a processor; and
a memory storing executable instructions which when executed on the processor causes the mobile voice communication device to provide functionality to a user of the mobile voice communication device, said executable instructions including implementing on the device a user interface that employs a plurality of different user prompts, wherein each user prompt of said plurality of different user prompts is for either soliciting a corresponding spoken input from the user or informing the user about an action or state of the device; implementing on the device a plurality of different earcons, each earcon of said plurality of different earcons being mapped to a corresponding different one of said plurality of user prompts; and when any selected one of said plurality of user prompts is issued by the user interface on the device, generating the earcon that is mapped to the selected user prompt.

13. The mobile voice communication device of claim 12, wherein the mobile voice communication device is a mobile telephone device.

14. The mobile voice communication device of claim 12, wherein the functionality that is provided by the executable instructions comprises speech recognition.

15. The mobile voice communication device of claim 12, wherein the executable instructions further comprises:
implementing a plurality of user selectable modes including a first mode in which whenever any of the plurality of different earcons is generated the corresponding language representation is also presented to the user and a second mode in which the plurality of different earcons are generated without presenting the corresponding language representation.

16. The mobile voice communication device of claim 12, wherein each of the plurality of different earcons comprise any distinctive sound.

17. The mobile voice communication device of claim 12, wherein the plurality of different earcons include at least one of compressed speech, a plurality of abstract sounds, and a plurality of sounds having different pitch, tone and frequency attributes.

18. A computer readable medium including stored instructions adapted for execution on a process, comprising:
instructions for implementing on the device a user interface that employs a plurality of different user prompts, wherein each user prompt of said plurality of different user prompts is for either soliciting a corresponding spoken input from the user or informing the user about an action or state of the device;
instructions for implementing on the device a plurality of different earcons, each earcon of said plurality of different earcons being mapped to a corresponding different one of said plurality of user prompts; and
instructions for when any selected one of said plurality of user prompts is issued by the user interface on the device, generating the earcon that is mapped to the selected user prompt.

19. The computer readable medium of claim 18, wherein the medium is disposed within a mobile telephone apparatus and operates in conjunction with a user interface.

20. The computer readable medium of claim 18, wherein each of the plurality of different earcons comprise a distinctive sound.

21. The computer readable medium of claim 18, wherein the plurality of different earcons include at least one of compressed speech, a plurality of abstract sounds, and a plurality of sounds having different attributes such as varying pitch, tone and frequency.

22. A mobile voice communication device, comprising:
a first communication mode selectable by a user, wherein the user interface of the device generates at least two different types of user prompts for either soliciting a corresponding spoken input from the user or informing the user about an action or state of the device, wherein one of the at least two prompts is a plurality of language prompts and one is a plurality of earcon prompts; and
a second communication mode selectable by the user, wherein the user interface of the device generates the plurality of earcon prompts without generating the associated plurality of language prompts.

23. The mobile communication device of claim 22, wherein once the user has learned the association between each of the plurality of language prompts and each of the plurality of earcon prompts, the user selects the second mode by disabling the plurality of language prompts.

24. The mobile communication device of claim 22, wherein each of the plurality of earcon prompts comprise a distinctive sound.

25. The mobile communication device of claim 22, wherein the plurality of earcon prompts comprise at least one of compressed speech, a plurality of abstract sounds, and a plurality of sounds having varying pitch, tone and frequency attributes.

26. The mobile communication device of claim 22, wherein the first communication mode further comprises audibly presenting said plurality of language prompts to the user.

27. The mobile communication device of claim 22, wherein the first communication mode further comprising visually presenting said plurality of language prompts.
